(19) United States
(12) Patent Application Publication
(10) Pub. No.: US 2023/0250990 A1
(43) Pub. Date: Aug. 10, 2023

(54) AIR-CONDITIONING CONTROL DEVICE

(71) Applicant: Mitsubishi Electric Corporation, Tokyo (JP)

(72) Inventors: Ryoma UDAKA, Tokyo (JP); Mio MOTODANI, Tokyo (JP); Masae SAWADA, Tokyo (JP)

(73) Assignee: Mitsubishi Electric Corporation, Tokyo (JP)

(21) Appl. No.: 18/015,081

(22) PCT Filed: Aug. 14, 2020
(86) PCT No.: PCT/JP2020/030899

§ 371 Date: Jan. 9, 2023

(51) Int. Cl. F24F 11/79; F24F 11/64; G05B 19/042

(52) U.S. Cl. CPC F24F 11/79; F24F 11/64; G05B 19/042; G05B 2219/2614

(57) ABSTRACT

An air-conditioning control device according to the present disclosure controls air-conditioning units that are an outdoor unit and a plurality of indoor units each having an air outlet. The air-conditioning control device includes: a storage device that stores set input data that includes a space set temperature set for a target space to be air-conditioned and space position information on the target space; and an arithmetic device that performs a control of the indoor units based on the set input data, such that air currents blown from the air outlets of the indoor units are caused to collide with each other in a space located just above the target space and air obtained by collision of the air currents and having the space set temperature is caused to reach the target space.

### TECHNICAL FIELD

The present disclosure relates to an air-conditioning control device that controls air-conditioning units.

### BACKGROUND ART

In the past, air-conditioning control techniques in which only a limited space is air-conditioned have been proposed. It is known that indoor areas where users are present are air-conditioned, and the difference between ways in which the users feel thermal environments is reflected in an air-conditioning control, whereby the comfort of each user is improved, and a great energy-saving effect can be expected compared with the case where the entire indoor space is air-conditioned.

In a given technique, when a plurality of areas are air-conditioned by a single indoor unit, the amount of heat to be processed by blown air for each of the areas is adjusted by adjusting a time period in which the blown air is guided in a predetermined direction by an air current-direction adjusting flap, and by causing temperatures of air to be blown into the respective areas to differ from each other. With this technique, it is possible that a plurality of areas having different temperatures are set in a single indoor space (see, for example, Patent Literature 1).

### CITATION LIST

### Patent Literature

Patent Literature 1: Japanese Unexamined Patent Application Publication No. 2018-040502

### SUMMARY OF INVENTION

### Technical Problem

However, in a control method disclosed in Patent Literature 1, a current of blown air (hereinafter referred to as blown air current) from an indoor unit that is located above a user flows to the user in an oblique direction to the user. Thus, an air current blown to a space of a certain area reaches a space of an area that is located adjacent to the certain area and leeward of the certain area. As a result, when another user is present in the space of the above adjacent area on the leeward side, the user may feel uncomfortable with the air current blown to the space of the certain area. In addition, in the case where users are present in respective spaces in adjacent areas, when the users set different setting temperatures for the respective spaces, and a blown air current from each of the areas reach the space of an adjacent area on the leeward side, the temperature of the area of the space where the user in the adjacent area is present does not easily reach the setting temperature set by the user.

The present disclosure is applied to solve the above problem, and relates to an air-conditioning control device that controls a blown air current to reduce the probability with which an air current blown to a space of a certain area will reach a space of another area located adjacent to and leeward of the certain area.

### Solution to Problem

An air-conditioning control device according to the present disclosure controls air-conditioning units that are an outdoor unit and a plurality of indoor units each having an air outlet. The air-conditioning control device includes: a storage device that stores set input data that includes a space set temperature set for a target space to be air-conditioned and space position information on the target space; and an arithmetic device that performs a control of the indoor units based on the set input data, such that air currents blown from the air outlets of the indoor units are caused to collide with each other in a space located just above the target space and air obtained by collision of the air currents and having the space set temperature is caused to reach the target space.

### Advantageous Effects of Invention

The air-conditioning control device according to an embodiment of the present disclosure controls a plurality of indoor units based on set input data stored in a storage device, such that air currents blown from air outlets of the indoor units are made to collide with each other in a space located just above a target space and air having a space set temperature is supplied to the target space, Therefore, it is possible to reduce as much as possible the probability with which a blown air current will reach another user who is present in a space located adjacent to and leeward of the target space in the flow direction of the blown air current.

### BRIEF DESCRIPTION OF DRAWINGS

FIG. 1 illustrates a configuration of an air-conditioning system including an air-conditioning control device 1 according to Embodiment 1.

FIG. 2 is a plan view illustrating an example of a room that is air-conditioned by the air-conditioning system according to Embodiment 1.

FIG. 3 is a schematic diagram (first diagram) for explanation of an advantage that is obtained by control by the air-conditioning control device 1 according to Embodiment 1.

FIG. 4 is another schematic diagram (second diagram) for explanation of the advantage that is obtained by control by the air-conditioning control device 1 according to Embodiment 1.

FIG. 5 illustrates a configuration example of the air-conditioning control device 1 according to Embodiment 1.

FIG. 6 is a diagram for explanation of a total momentum of a plurality of blown air currents and conservation of momentum at an air-current collision point in Embodiment 1.

FIG. 7 is a diagram for explanation of an equilibrium of momenta of a plurality of blown air currents in a horizontal direction in Embodiment 1.

FIG. 8 is a diagram for explanation of processing by a space information processing module 12a and a momentum calculation module 12b in Embodiment 1.

FIG. 9 is a diagram for explanation of processing by the air-conditioning control device 1 according to Embodiment 1,

FIG. 10 is a schematic diagram (first diagram) for explanation of a conceivable situation in Embodiment 2.

FIG. 11 is another schematic diagram (second diagram) for explanation of the conceivable situation in Embodiment 2.

FIG. 12 is still another schematic diagram (third diagram) for explanation of the conceivable situation in Embodiment 2.

FIG. 13 illustrates a configuration example of the air-conditioning control device 1 according to Embodiment 2.

FIG. 14 is a diagram for explanation of the flow of processing by the air-conditioning control device 1 according to Embodiment 2.

FIG. 15 is a diagram for explanation of a conceivable situation in Embodiment 3.

FIG. 16 illustrates a configuration example of the air-conditioning control device 1 according to Embodiment 3.

FIG. 17 illustrates an example of set values for air-conditioning that are used as boundary conditions in a calculation by a calculation performing module 12g according to Embodiment 3.

FIG. 18 is a diagram for explanation of processing by the air-conditioning control device 1 according to Embodiment 3.

### DESCRIPTION OF EMBODIMENTS

Embodiments of the air-conditioning control device will be described with reference to the drawings. In each of figures to be referred to below, components that are the same as or equivalent to those in a previous figure or previous figures are denoted by the same reference signs, and the same is true of the entire text of the specification relating to the embodiments. Furthermore, the configurations of components described in the specification are merely examples: that is, the actual configurations of the components are not limited to the configurations described in the specification. In particular, in the case where components are combined, it is not limited to the case where components according to the same embodiment are combined. A component in an embodiment can be applied to another embodiment as appropriate. Furthermore, with respect to temperature, whether each of values is higher or lower is relatively determined based on the state, operation, etc., of a system, an apparatus, a device, etc., not based on the relationship between the value and an absolute value. In addition, with respect to a plurality of devices that are of the same type and distinguished from each other by suffixes, in the case where they do not particularly need to be identified or distinguished from each other, the suffixes may be omitted. Moreover, a height direction in a room to be air-conditioned may be referred to as an up-down direction or a Z-axis direction, and a horizontal direction in the room may be referred to as a lateral direction. The horizontal direction is also an X-axis direction or a Y-axis direction.

### Embodiment 1

### <Configuration of Air-Conditioning System>

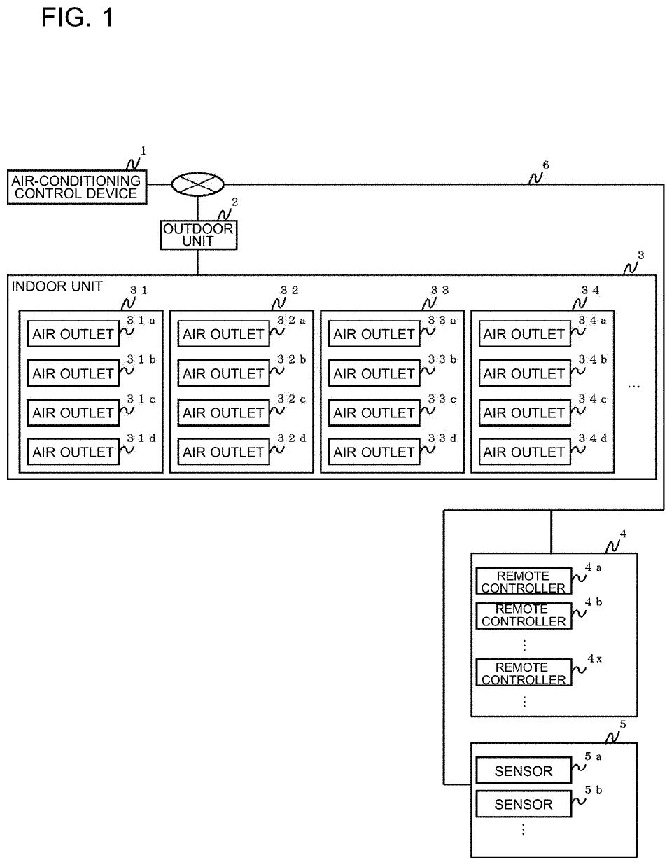

FIG. 1 illustrates a configuration of an air-conditioning system including an air-conditioning control device 1 according to Embodiment 1. The air-conditioning control device 1 is connected to an outdoor unit 2, a remote controller 4, and a sensor 5 via a control network 6, which is a telecommunication line, such that the air-conditioning control device can communicate with the outdoor unit 2, the remote controller 4, and the sensor 5, and can thus transmit and receive a signal to and from the outdoor unit 2, the remote controller 4, and the sensor 5. In Embodiment 1, an indoor unit 3 is connected to the air-conditioning control device 1 via the outdoor unit 2 such that the indoor unit 3 can communicate with the air-conditioning control device 1. The air-conditioning control device 1 controls the outdoor unit 2 and the indoor unit 3, which are air-conditioning units that are included in an air-conditioning apparatus. The air-conditioning control device 1 will be described later.

The outdoor unit 2 is an air-conditioning unit that cools or heats a heat medium, such as refrigerant or water, and sends the heat medium to the indoor unit 3, thereby transferring heat to the indoor unit 3. The indoor unit 3 is an air-conditioning unit that causes heat exchange to be performed between the heat medium sent from the outdoor unit 2 and indoor air, and adjusts the temperature, etc., in a room, thereby air-conditioning an internal space of the room. In Embodiment 1, the indoor unit 3 includes a plurality of indoor units 31, 32, 33, and 34 in a single room. The indoor unit 3 is installed at a ceiling surface 200, which is located at the highest position in the room in the height direction, as described later. The ceiling surface 200 is a surface extending in a direction parallel to the horizontal direction. The indoor unit 31 includes air outlets 31a, 31b, 31c, and 31d; likewise, the indoor unit 32 includes air outlets 32a, 32b, 32c, and 32d; likewise, the indoor unit 33 includes air outlets 33a, 33b, 33c, and 33d; and likewise, the indoor unit 34 includes air outlets 34a, 34b, 34c, and 34d. In the following description, in the case where the indoor units 31 to 34 do not need to be distinguished from each other, the indoor units 31 to 34 are described as indoor units 3 each having air outlets 30.

The remote controller 4 is a device to which various settings are input as data by a user 100, which will be described later. The remote controller 4 transmits a signal including data, such as a set value, which is related to inputting, to the air-conditioning control device 1. The transmitted data is stored in the air-conditioning control device 1. Data to be input by the user 100 is, for example, data on set values regarding air-conditioning, such as data on switching on and off of the indoor unit 3, and a space set temperature, except data on the direction of an air current blown out from an air outlet (which will be hereinafter referred to as an air current direction), which will be described later, and the velocity of the air current blown out from the air outlet 30 (which will be hereinafter referred to as air current velocity). Also, the data to be input by the user 100 is data on an area or a target space to be air-conditioned (hereinafter referred to as a target space). However, it should be noted that when the remote controller 4 can obtain data on the position of the remote controller 4 itself, the user 100 does not have to input data on the target space. Using the remote controller 4, the user 100 selects a target space and manually input settings such as a space set temperature for the selected target space. In this case, in the case where, for example, a personal computer or a tablet terminal is made to have the function of the remote controller 4, the personal computer or tablet terminal can be used as the remote controller 4.

The sensor 5 is a detection device that measures a physical quantity. The sensor 5 of Embodiment 1 includes a plurality of sensors 5a and 5b. The sensor 5 measures a physical quantity related to indoor and outdoor environments such as, for example, temperature, humidity, radiation temperature, thermal image, or air velocity. A device incorporated into the outdoor unit 2 or the indoor unit 3 to detect a temperature may be used as the sensor 5. In addition to the device detecting a physical quantity, a device such as a camera that obtains shape information on the interior of a room or a human detecting sensor that detects a person who is present in the room can be used as the sensor 5. In this case, regarding the indoor and outdoor environments, an outdoor temperature may be obtained from information, such as forecast information, which is obtained from an external device via a telecommunications line.

The control network 6 corresponds to telecommunication lines for communication that connect, as described above, the air-conditioning control device 1, the outdoor unit 2, the remote controller 4 and the sensor 5. It should be noted that regarding the control network 6, for example, the type of a cable and a protocol for communication are not limited to specific ones. For example, the control network 6 may be a wired communication, such as a local area network (LAN), or a wireless communication. In addition, the control network 6 may be a network that uses a general-purpose protocol that is available to the public. Furthermore, the control network 6 may use a dedicated line and a dedicated protocol specified by the manufacturer of the outdoor unit 2 or the indoor unit 3.

### <Target Space>

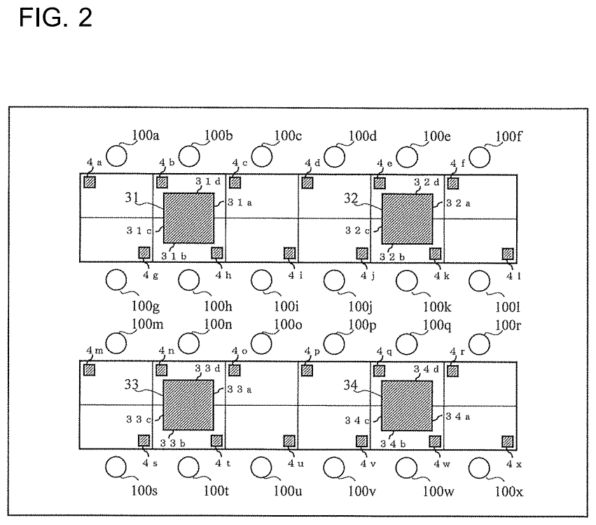

FIG. 2 is a plan view illustrating an example of a room that is air-conditioned by the air-conditioning system according to Embodiment 1. The room as illustrated in FIG. 2 includes a target space that is to be air-conditioned. FIG. 2 illustrates an example of positional relationships between the indoor units 31 to 34 the air outlets 31a to 34d of the indoor units 31 to 34, users 100a to 100x who use the room, and remote controllers 4a to 4x that the users 100a to 100x use for input. A plurality of indoor units 3 each having a plurality of air outlets 30 is installed in the room. The users 100a to 100x are present adjacent to each other in the room, and may be adjacent to each other, with desks interposed between the users in the room. The remote controllers 4a to 4x are placed near the respective users.

### <Assumed Situation>

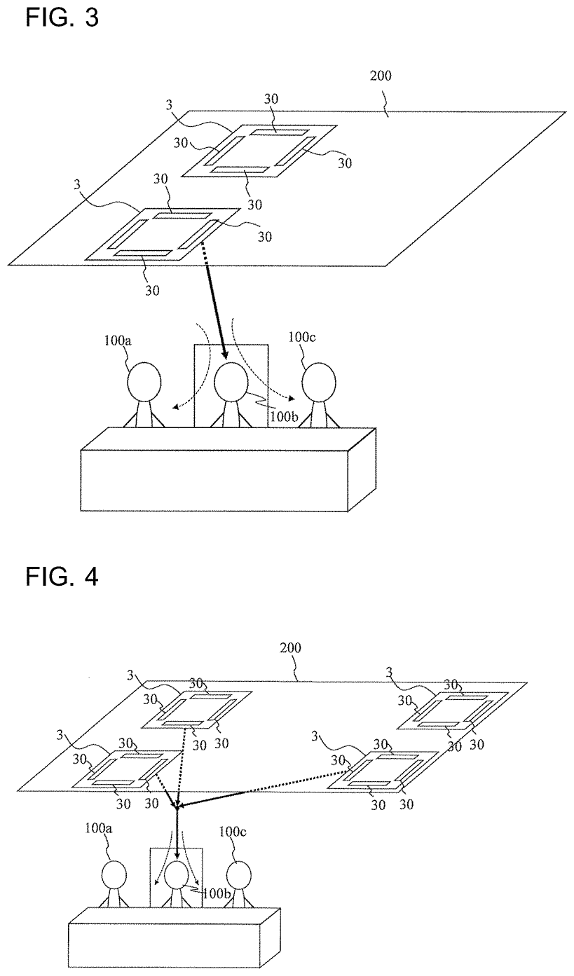

FIGS. 3 and 4 are schematic diagrams for explanation of an advantage that is obtained by control by the air-conditioning control device 1 according to Embodiment 1. FIG. 3 is a schematic diagram illustrating the case where an air current is blown from one of the air outlets 30 of one of the indoor units 3 that are located at the ceiling surface 200 in the height direction to air-condition a target space where the user 100b is present. In this case, it is assumed that the users 100a to 100c are present in the room and the user 100a and the user 100c are present in respective areas adjacent to an area including the target space where the user 100b is present.

The user 100b sets a desired space set temperature for the target space where the user 100b is present. When an air current is blown from one of the air outlets 30 of one of the indoor units 3 to the target space where the user 100b is present, the air current is blown to the target space from a position located diagonally above the target space. Thus, the blown air current reaches not only to the target space but also to adjacent spaces where the users 100a and the users 100c are present. Therefore, air having a temperature different from desired temperatures for the users 100a and 100c reaches the users. Accordingly, in this state, the users 100a and 100c easily feel uncomfortable with the air.

In view of the above, the air-conditioning control device 1 of Embodiment 1 controls air-conditioning units such that air currents blown from air outlets 30 of the indoor units 3 are caused to collide with each other at a space located just above the target space where the user 100b is present, whereby air having the space set temperature reaches the target space, as illustrated in FIG. 4. The air having the space set temperature is caused to reach the user 100b from the space located just above the target space, thereby reducing as much as possible the probability with which peripheral air currents may reach the user 100a and the user 100c in the adjacent spaces. As a result, in this state, the users 100a and 100c do not easily feel uncomfortable, compared with the case as illustrated in FIG. 3.

### <Configuration of Air-Conditioning Control Device 1>

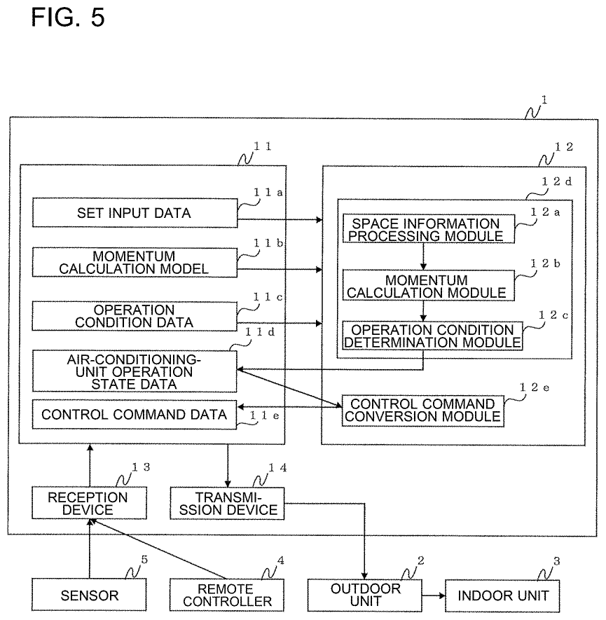

FIG. 5 illustrates a configuration example of the air-conditioning control device 1 according to Embodiment 1. The air-conditioning control device 1 as described above includes a storage device 11 including, for example, a memory, an arithmetic device 12 including, for example, a processor, a reception device 13 that receives various signals, and a transmission device 14 that transmits various signals. The configuration of the air-conditioning control device 1 will be described in detail with reference to FIG. 5.

### <Storage Device 11>

The storage device 11 stores set input data 11a, a momentum calculation model 11b, operation condition data 11c, air-conditioning-unit operation state data 11d, control command data 11e, etc. The storage device 11 includes, for example, a volatile storage device (not illustrated), such as a random access memory (RAM), which can temporarily store data, and a nonvolatile auxiliary storage device (not illustrated), such as a hard disk, which can store data for a long time.

The operation condition data 11c stored in the storage device 11 is data on various conditions that are required when units included in the arithmetic device 12 perform processing. For example, information on the configuration of the air-conditioning units that are included in the air-conditioning apparatus, such as the number of the outdoor units 2 and the indoor units 3 and a connection relationship between the outdoor units 2 and the indoor units 3, is operation condition data 110 related to the air-conditioning units. Other kinds of information, such as control specifications of the outdoor unit 2, the indoor-unit set temperature of each indoor unit 3, control specifications such as air current velocity, air current direction, and temperature of an air current blown from each air outlet 30, and air-outlet position information on the air outlets 30 of each indoor unit 3, are also used as the operation condition data 11c related to the air-conditioning units. In addition, position information of furniture and fixtures, such as desks placed in the room and chairs on which the users sit, shape information on the room, such as interior walls, exterior walls, and windows, and information on the relative distances between the furniture and fixtures are used as operation condition data 11c related to indoor conditions. In this case, the operation condition data 11c may include, as data, information on zone division, which is performed based on areas that are handled by the respective indoor units 3. In Embodiment 1, because air currents having the same temperature are blown from the air outlets 30 of the indoor units 3, the indoor-unit set temperature is used as the space set temperature.

The set input data 11a stored in the storage device 11 is data including space set temperatures included in signals transmitted from the remote controllers 4, set values related to each indoor unit 3, except air current direction and air current velocity of a blown air current from each air outlet 30, and space position information on the target space. In this case, a set value that is input using a personal computer or a tablet terminal as the remote controller 4 may be used as the set input data 11a.

Furthermore, the storage device 11 stores the air-conditioning-unit operation state data 11d and the control command data 11e. The air-conditioning-unit operation state data 11d is data on an air-conditioning-unit operation state determined by an operation condition determination module 12c, which will be described later. The control command data 11e is data on a control command into which the air-conditioning apparatus operation state is converted by a control command conversion module 12e, which will be described later.

<Momentum Calculation Model 11b>

The momentum calculation model 11b stored in the storage device 11 is data obtained by modeling a relationship between data included in the operation condition data 11c, data included in set input data 11a, and a calculation formula for calculating the momentum of a blown air current. More specifically, the operation condition data 11c is, as described above, information on the configuration of the air-conditioning units, such as information on the number of the indoor units 3 and the air-outlet position information, and control specifications, such as air current velocities and air current directions of air currents blown from air outlets 30 of the indoor units 3. In addition, the operation condition data 11c includes position information on furniture and fixtures set in the room, and shape information on the room, and information on the relative distances between the furniture and fixtures in the room. The set input data 11a is information on the space set temperature for the target space, and position information on the target space. The momentum calculation model 11b is data obtained by modeling a relationship between the operation condition data 11c, the set input data 11a, and the calculation formula for calculating the momentum of a blown air current.

As a method of calculating the momentum of a blown air current based on the operation condition data 11c and the set input data 11a, for example, in a given method, the momentum is calculated based on a relationship in which the total momentum of air currents blown out from the plurality of air outlets 30 is conserved at a blow-out time, a collision time, and an arrival time when the blown air current is blown out, the blown air currents collides with each other, the blown air arrives at the target space. Furthermore, in another method, the momentum is calculated using a calculation that takes into account the fact that the velocity of the air current blown from each of the air outlets 30 decreases as the distance between the blown air current and the air outlet 30 increases. In addition, in still another method, the momentum is calculated by a calculation that takes into account the fact that the velocity of the air current blown from each air outlet 30 decreases when the blown air current collides with another blown air current.

The calculation in which a relationship in which the momenta of air currents blown out from the plurality of air outlets 30 are conserved at the blown-out time, the collision time, and the arrival times is taken into account, uses the following equations (1) to (4). The equations (1) to (4) represent a relationship between the velocity and the momentum of an blown air current, an equilibrium in horizontal-direction components of momenta of the blown air currents, and a relationship between the total momentum of blown air currents at the blown-out time and conservation of the momentum of the air currents at the collision time and the arrival time.

[Math. 1]

Jᵢ=Sᵢ(ρᵢvᵢ²+pᵢ) (1)

[Math. 2]

ΣJᵢ sin φᵢ=Jₘ=Jₙ (2)

[Math. 3]

ΣJᵢ cos θᵢ cos φᵢ=0 (3)

[Math. 4]

ΣJᵢ sin θᵢ cos φᵢ=0 (4)

The equation (1) expresses a relationship between the velocity and the momentum of a blown air current. The equation (2) indicates that the total momentum of a plurality of blown air currents, the momentum of air obtained from collision of the air at an air-current collision point m thereof, and the momentum of the air current at a point n in a target space, which is located just below the air-current collision point m, are conserved in a direction perpendicular to the ceiling surface 200.

Ji is the momentum [kg·m/s2] of an air current blown out from an air outlet 30i per unit time, Si is the area [m2] of an air outlet 30i, ρi is the air density [kg/m3] of the blown air current from the air outlet 30i, vi is the velocity [m/s] of the air current from the air outlet 30i, and pi is the static pressure [Pa] at a position i.

Jm is the momenta of air obtained from collision of the air at the air-current collision point m, and Jn is the momenta of the air at the point n in the target space located just below the air-current collision point m. The momentum Jₘ can be obtained from the equation (1), using a velocity vₘ, an air density ρₘ of blown air current, an area Sₘ of a plane which extends from the air-current collision point m serving as a center and at which an air current parallel to the ceiling surface 200 arrives, and a static pressure pₘ at the air-current collision point m. The momentum Jₙ can be obtained from the equation (1), using a velocity vₙ, an air density ρₙ, an area Sₙ of a plane which extends from the point n serving as a center, and at which an air current parallel to the ceiling surface 200 arrives, and a static pressure pₙ at the point n. The level of a working surface generally used, such as the position of the head of the user 100, is used as an indoor level, which is the position of the air-current collision point m or the point n in the target space in the height direction. The velocity vₙ at the point n in the target space is the velocity of air that reaches the user 100. For example, the velocity of an air current, which is obtained based on the results of experiments conducted in advance and at which people usually feel comfortable, is used as the velocity vₙ. The air densities ρₘ and ρₙ, the areas Sₘ and Sₙ, and the static pressures pₘ and pₙ may be determined based on, for example, a relational expression with another physical quantity, such as a temperature. The air densities ρₘ and ρₙ, the areas Sₘ and Sₙ, and the static pressure pₘ and pₙ may be determined based on the results of experiments performed in advance. Furthermore, ϕᵢ is the angle between the blown air current from the air outlet 30i and a plane parallel to the ceiling surface 200, and θᵢ is the angle between the blown air current from the air outlet 30i and the X-axis direction (any direction in the plane parallel to the ceiling surface 200).

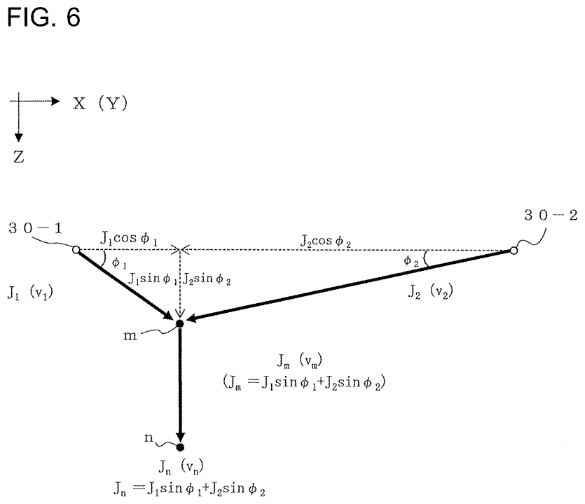

FIG. 6 is a diagram for explanation of the total momentum of a plurality of blown air currents and conservation of momentum at an air-current collision point in Embodiment 1. FIG. 6 illustrates the case where air currents are blown from two air outlets 30-1 and 30-2. J₁ and J₂ are momenta of respective blown air currents per unit time when the air currents are blown from the air outlet 30-1 and 30-2 at the velocities v1 and v2 and at the vertical-direction angles ϕ1 and ϕ2 from the ceiling surface 200, respectively. The sum of the momenta of the blown air currents including J1 sin ϕ1 and J2 sin ϕ2, which are components in a height direction (Z-axis direction) perpendicular to the ceiling surface 200, is the total momentum of the blown air currents in Z-axis direction. The total momentum in the Z-axis direction is conserved from a logical maximum velocity line I serving gas the central axis to the air-current collision point m and at the point n located just below the air-current collision point m. In this case, Ji in the equation (2) is obtained by solving the equations (3) and (4) simultaneously such that the conserved total momentum (J1 sin ϕ1+J2 sin ϕ2) in the Z-axis direction is equalized to the momentum Jₙ of air at the point n in the target space (at velocity vₙ at this time).

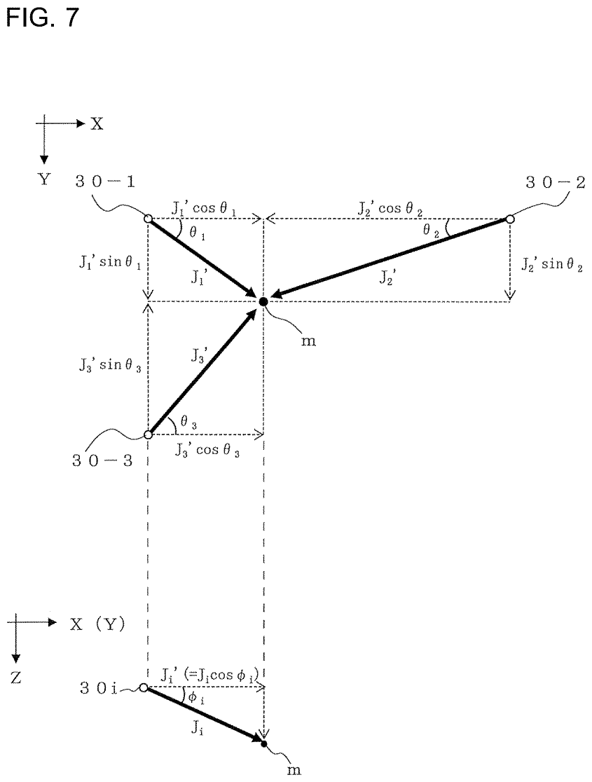

FIG. 7 is a diagram for explanation of an equilibrium of the momenta of the plurality of blown air currents in the horizontal direction in Embodiment 1. FIG. 7 illustrates the case where air currents are blown from three air outlets 30-1, 30-2, and 30-3. The equations (3) and (4) will be described based on FIG. 7. The equation (3) expresses the equilibrium of the momenta of blown air currents in the X-axis direction. The equation (4) expresses the equilibrium of the momenta of blown air currents in the Y-axis direction.

J₁′, J₂′, and J₃′ are momenta of respective air currents in an XY plane per unit time when the air currents are blown out from the air outlets 30-1, 30-2, and 30-3 at the velocities vᵢ, v₂, and v₃ and at the vertical-direction angles ϕ₁, ϕ₂, and ϕ₃ from the ceiling surface 200, respectively. In this case, it is assumed that the air currents blown from the plurality of air outlets 30 collide with each other at the air-current collision point m and then flow toward the point n in the target space located just blow the air-current collision point m. Thus, the momenta of the blown air currents (J₁′ cos θ₁+J₂′ cos θ₂+J₃′ cos θ₃ in FIG. 7, wherein J₂′ cos θ₂<0) in the X-axis direction are balanced. In addition, the momenta of the blown air currents (J₁′ sin θ₁+J₂′ sin θ₂+J₃′ sin θ₃ in FIG. 7, wherein J₁′ sin θ₃<0) in the Y-axis direction are also balanced. Accordingly, in each of the above cases, the total momentum is zero.

### <Arithmetic Device 12>

The arithmetic device 12 of Embodiment 1 includes an air-current passage determination module 12d and a control command conversion module 12e. As hardware, the arithmetic device 12 is, for example, a microcomputer that includes a control arithmetic processing device, such as a central processing unit (CPU), an analog circuit, and a digital circuit.

<Air-Current Passage Determination Module 12d>

The air-current passage determination module 12d determines an air current passage such that a blown air current reaches the target space from a position located just above the target space. In Embodiment 1, the air-current passage determination module 12d includes a space information processing module 12a, a momentum calculation module 12b, and an operation condition determination module 12c.

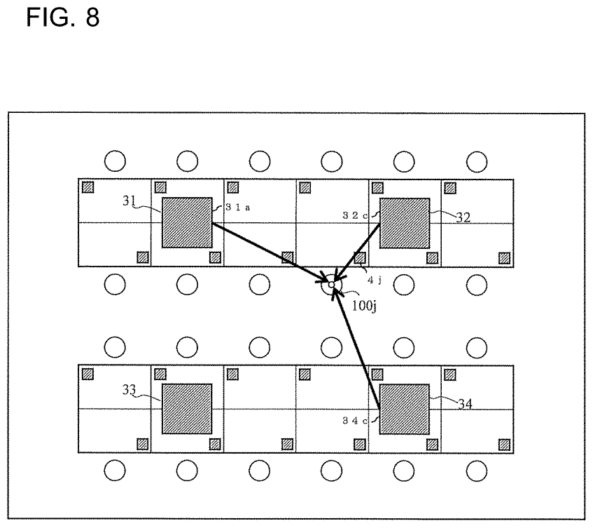

FIG. 8 is a diagram for explanation of processing by the space information processing module 12a and the momentum calculation module 12b in Embodiment 1. FIG. 8 is an example of a plan view of the inside of a room, for explanation of processes in which the space information processing module 12a and the momentum calculation module 12b output flow directions and velocities of a plurality of blown air currents. FIG. 8 illustrates the case where a user 100j inputs a desired space set temperature, using an associated remote controller 4j, with the position of the user 100j set as the target space.

<Space Information Processing Module 12a>

The space information processing module 12a is configured to select a plurality of air outlets 30 for use in control, from among the air outlets 30 of the plurality of indoor units 3, based on the space position information on the target space for which the user 100 inputs the space set temperature, the air-outlet position information on the air outlets 30 of each indoor unit 3, the information on furniture and fixtures in the room, and the shape information on the room. Then, for each of the selected air outlets 30, the space information processing module 12a determines the flow direction of an air current blown out from the air outlet 30 and outputs the result of the above determination. In Embodiment 1, the space information processing module 12a selects air outlets 30 and determines the flow direction of each blown air current for a single target space, based on an input from the user 100 via the remote controller 4 and other information.

Referring to FIG. 8, based on target position information on the target space where the user 100j is present, the air-outlet position information on the air outlets 30, the information on furniture and fixtures in the room, the shape information on the room, and other information, a plurality of air outlets 30 for use in air-conditioning the target space are selected from different indoor units 3 in the following procedure. Then, the flow direction of the blown air current is determined for each of the selected air outlets 30, and the result of the determination is output. First, the space information processing module 12a sets one air-current collision point, at which the plurality of blown air currents will collide with each other, in a space located just above the target space where the user 100j is present, based on the space position information on the target space where the user 100j is present. Next, based on collision-point position information on the set air-current collision point, the air-outlet position information on the indoor units 3 and the air outlets 30 that is included in the operation condition data 11c, and other information, the space information processing module 12a selects two air outlets 30 or three or more air outlets 30 that are the closest to the set air-current collision point. In an example as illustrated in FIG. 8, three air outlets 31a, 32c, and 34c are selected for the target space where the user 100j is present. Then, the space information processing module 12a determines, for each of the selected air outlets 30, up-down and lateral flow directions of the air current toward the air-current collision point, as viewed from the selected air outlet 30, and outputs the result of the determination.

When the air-current collision point can be set at a point on a line that connects two different air outlets 30, the space information processing module 12a selects the two air outlets 30. When the air-current collision point is set at any other position, the space information processing module 12a selects three or more air outlets 30. As an exception, in the case where no problem arises even when a blown air current reaches the leeward side of the target space, such as the case where a wall or another obstacle is present near the leeward side of the target space, air-conditioning may be performed using a single air outlet 30 without setting any air-current collision point.

<Momentum Calculation Module 12b>

The momentum calculation module 12b determines the velocity of an air current blown out from each air outlet 30, using the momentum calculation model 11b stored in the storage device 11, based on the flow direction of the air current blown out from the air outlet 30 that is determined by the space information processing module 12a, and outputs the result of the determination.

FIG. 8 indicates that air currents which are blown from the air outlets 31a, 32c, and 34c selected by the momentum calculation module 12b and whose flow directions are determined by the space information processing module 12a and whose velocities are determined by the momentum calculation module 12b collide with each other at the air-current collision point located in a space located just above the target space where the user 100j is present. Then, air obtained by the collision of the blown air currents reaches the target space where the user 100j is present. Thus, the temperature of the target space reaches a desired temperature for the user 100j. In addition, the flow of an air current toward each of other users 100 located around the user 100j is reduced. It is therefore possible to reduce the degree to which the other users 100 feel uncomfortable with the air current, to the minimum.

<Operation Condition Determination Module 12c>

The operation condition determination module 12c stores in the storage device 11, as the air-conditioning-unit operation state data 11d, the space set temperature included in the set input data 11a, and the flow direction and the velocity of the air current blown out from each air outlet 30 that are output from the space information processing module 12a and the momentum calculation module 12b. In this case, the space set temperature is the same temperature as indoor-unit set temperatures set in the indoor units 3.

<Control Command Conversion Module 12e>

The control command conversion module 12e converts the air-conditioning-unit operation state data 11d stored in the storage device 11 into control command data 11e that corresponds to commands to be actually given to the outdoor unit 2 and the indoor units 3 that are the air-conditioning units to be controlled.

### <Reception Device 13 and Transmission Device 14>

The reception device 13 receives signals including various data from the remote controller 4 and the sensor 5. The data received by the reception device 13 is stored in the storage device 11. The transmission device 14 transmits signals including the control command data 11e stored in the storage device 11 to the outdoor unit 2 and the indoor units 3.

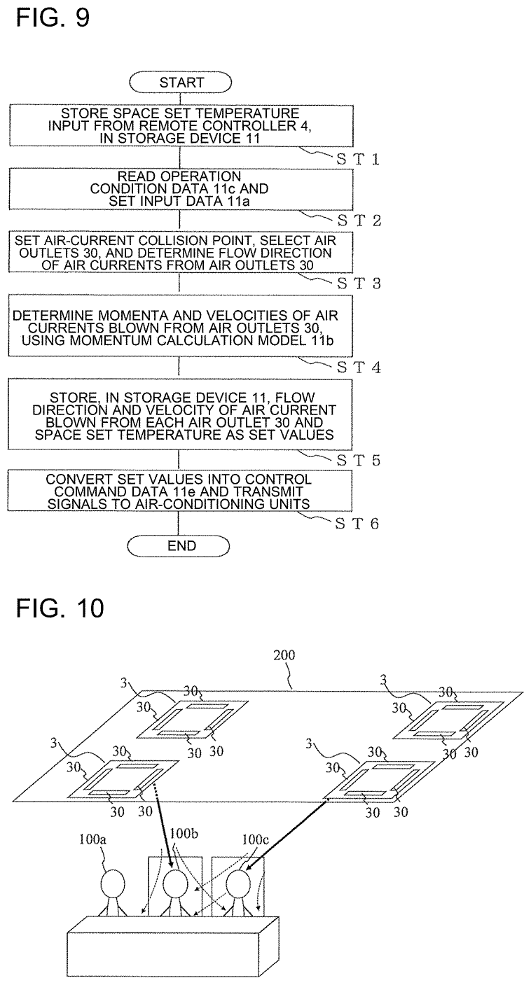

FIG. 9 is a diagram for explanation of processing by the air-conditioning control device 1 according to Embodiment 1. The processing by the air-conditioning control device 1 is performed mainly by the arithmetic device 12. The processing by the air-conditioning control device 1 will be described together with the flow of processing of the entire air-conditioning system.

In step ST1, a space set temperature for a target space that is input by the user 100 via the remote controller 4 is transmitted to the air-conditioning control device 1, and received by the reception device 13. Then, the data on the space set temperature is stored in the storage device 11 as the set input data 11a (step ST1).

In step ST2, the arithmetic device 12 reads, from the storage device 11, the operation condition data 11c, such as the control specifications of the indoor units 3, the number of the indoor units 3, position information on the indoor units 3, and indoor shape information, and the set input data 11a including the space set temperature (step ST2).

In step ST3, the space information processing module 12a of the arithmetic device 12 sets an air-current collision point based on the operation condition data 11c and the set input data 11a obtained in step ST2. Furthermore, the space information processing module 12a selects air outlets 30 of a plurality of indoor units 3 for air-conditioning the target space, based on the position information on the set air-current collision point. Then, the space information processing module 12a calculates up-down and lateral flow directions of air currents from the selected air outlets 30, relative to the air-current collision point (step ST3).

In step ST4, the momentum calculation module 12b of the arithmetic device 12 calculates the momenta of air currents blown from the air outlets 30, using the momentum calculation model 11b stored in the storage device 11. Furthermore, the momentum calculation module 12b calculates the velocities of the air currents blown from the air outlets 30 (step ST4).

In step ST5 the operation condition determination module 12c of the arithmetic device 12 determines as new air-conditioning set values, the flow direction of an air current from each selected air outlet 30 that is determined in step ST3, the velocity of the air current from the air outlet 30 that is determined in step ST4, and the space set temperature included in the set input data 11a. Then, the operation condition determination module 12c stores in the storage device 11, the determined air-conditioning set values as the air-conditioning-unit operation state data 11d (step ST5).

In step ST6, the control command conversion module 12e of the arithmetic device 12 converts the set values stored as the air-conditioning-unit operation state data 11d in the storage device 11 into control command data 11e. The control command conversion module 12e also stores the control command data 11e in the storage device 11. Then, the transmission device 14 transmits signals including the control command data 11e to the outdoor unit 2 and the indoor units 3 to update the air-conditioning-unit operation state (step ST6).

As described above, the air-conditioning control device 1 of Embodiment 1 includes the storage device 11 that stores the set input data 11a, the momentum calculation model 11b, the operation condition data 11c, the air-conditioning-unit operation state data 11d, and the control command data 11e. The air-conditioning control device 1 also includes the control command conversion module 12e and the arithmetic device 12 that includes the air-current passage determination module 12d. In the air-current passage determination module 12d, the space information processing module 12a, the momentum calculation module 12b, and the operation condition determination module 12c are provided. Furthermore, the air-conditioning control device 1 of Embodiment 1 controls, for a single target space where a user 100 who sets and inputs the space set temperature is present, a plurality of blown air currents such that the plurality of blown air currents flows to the target space from a position located just above the target space. It is therefore possible to reduce as much as possible the flow of the blown air currents toward another user 100 who is present in an adjacent space located leeward of the target space in the flow direction of the blown air current. Thus, the air-conditioning control device 1 is capable of controlling blown air currents to reduce the probability with which other users 100 will feel uncomfortable with unwanted air currents.

### Embodiment 2

Next, an air-conditioning control device 1 according to Embodiment 2 will be described. The air-conditioning control device 1 of Embodiment 1 controls air-conditioning that is performed on a single target space, whereas the air-conditioning control device 1 of Embodiment 2 controls air-conditioning that is performed on two or more target spaces. The air-conditioning control device 1 of Embodiment 2 performs the control of the blown air current that is performed in Embodiment 1, for two or more target spaces one by one in a predetermined order.

Therefore, even when desired temperatures for a plurality of users 100 who are adjacent to each other are different from each other, temperatures in target spaces in which the users 100 are present can be individually made to reach the respective desired temperatures for the users 100, because of the above feature in which each of blown air currents does not easily reach an adjacent space that is located adjacent to the target space and leeward of the target space. It should be noted that in Embodiment 2, not all the space set temperatures set by all the users 100 need to be different, and some or all of the users 100 may input the same space set temperature via the remote controllers 4.

FIGS. 10, 11, and 12 are schematic diagrams for explanation of a conceivable situation in Embodiment 2. FIG. 10 illustrates the case where the user 100b and the user 100c input in this order, different space set temperatures for the respective positions of themselves, and air-conditioning is performed for these users, using respective air outlets 30. Referring to FIG. 10, for each of users 100, an air current blown from a position located diagonally above the user 100 flows to the user 100, and a peripheral air current of the above blown air current thus reaches another user 100 who is present adjacent to and leeward of the above user 100. Consequently, the peripheral air current makes the other user 100 on the leeward side feel uncomfortable. In addition, because each of target spaces is affected by an air current that is blown to another user, it is hard to achieve a desired temperature in the target space. In particular, the greater the difference between the set vales set by adjacent users, the more easily the adjacent users feel uncomfortable. It should be noted that the difference between the set values corresponds to disagreement between set modes, such as cooling mode and heating mode, or the difference between space set temperatures.

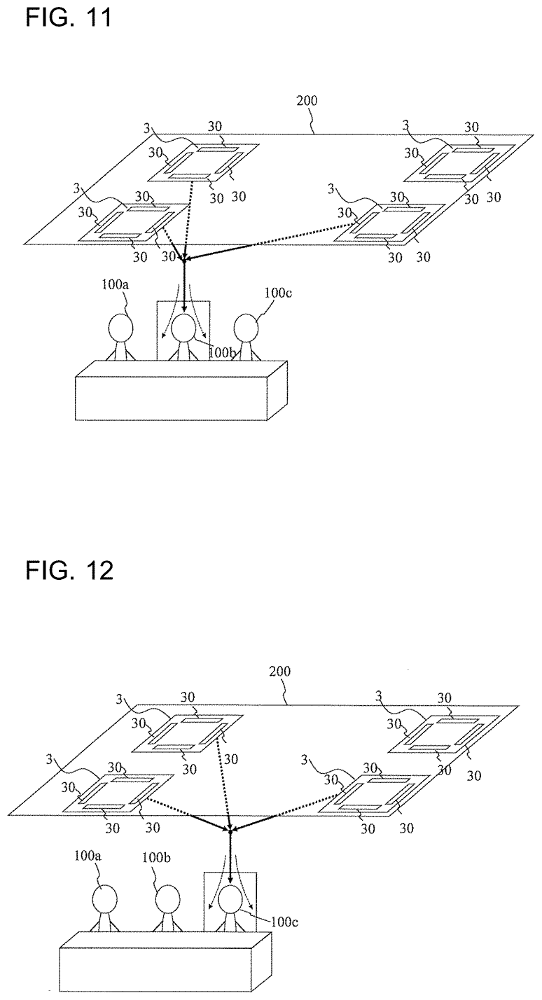

On the other hand, FIGS. 11 and 12 each illustrates the case where the users 100b and 100c input in this order, different space set temperatures for their positions that are target positions, and air-conditioning is performed using the air-conditioning control device 1 of Embodiment 2. As illustrated in FIG. 11, air currents blown out from a plurality of air outlets 30 are caused to collide with each other in a space located just above the user 100b, who has first input the space set temperature via the remote controller 4b, and an air current obtained by collision of the above air currents is caused to reach the user 100b from the space located just above the user 100b, whereby the temperature in the target space reaches the space set temperature set by the user 100b that is a desired temperature for the user 100b. After the elapse of a predetermined time period, as illustrated in FIG. 12, in the same procedure as described above for the user 100b, the air current is caused to reach the user 100c from a space located just above the user 100c, whereby the temperature in the target space reaches the space set temperature set by the user 100c that is a desired temperature for the user 100c. As illustrated in FIGS. 11 and 12, air currents flow into respective target spaces where the users 100b and 100c are present, from respective positions located just above the users 100b and 100c, thereby reducing the probability with which the air current for the associated user will flow into a target space where another user is present. Therefore, even when the difference between the set value set by the user 100b and that by the user 100c is great, each of the users 100b and 100c does not easily feel uncomfortable due to the difference, compared with the case as illustrated in FIG. 10.

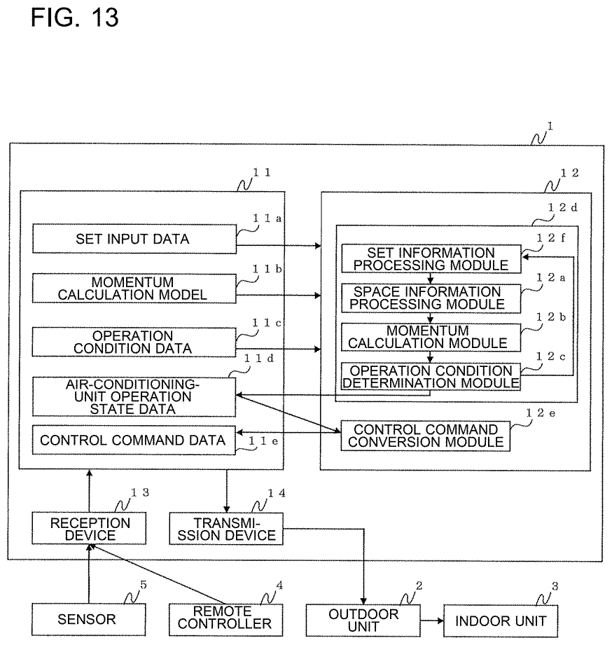

FIG. 13 illustrates a configuration example of the air-conditioning control device 1 according to Embodiment 2. In FIG. 13, components that are the same as or equivalent to those in FIG. 5 are denoted by the same reference signs. As illustrated in FIG. 13, in the air-conditioning control device 1 of Embodiment 2, the arithmetic device 12 further includes a set information processing module 12f.

<Set Information Processing Module 12f>

The set information processing module 12f is included in the air-current passage determination module 12d. The set information processing module 12f determines, in association with a control procedure, the duration of control for each of target spaces and a control order that is the order in which the target spaces are controlled, based on the space set temperatures and position information on the target spaces that are included in the set input data 11a, The set information processing module 12f then outputs, as data, the space position information on each target space to the space information processing module 12a. In addition, the set information processing module 12f outputs, to the operation condition determination module 12c, data on the control procedure related to the duration of control of each target space and the above control order for the target spaces.

A method of determining the duration of the control of each target space by the set information processing module 12f is not limited to a specific one. For example, the duration of the control may be a certain period of time determined based on the result of an experiment performed in advance. The duration of the control may vary from one target space to another. For example in a given target space, the duration of the control may be a time period required until the temperature in the target space reaches a desired temperature that is input by the user 100 who is present in the given target space, via the remote controller 4.

Similarly, a method of determining using the set information processing module 12f, the control order that is the order in which the target spaces are controlled is not limited to a specific one. For example, this order is determined as the order in which the space set temperatures for the target spaces are input via the remote controllers 4 or as the descending order in the difference between the temperature measured by the sensor 5, which measures the temperature of a space located around each user 100 in the room, and the space set temperature input by the user 100.

### <Operation Condition Determination Module 12c of Embodiment 2>

In Embodiment 2, in addition to the processing described regarding Embodiment 1, the operation condition determination module 12c performs processing based on the control order for the target spaces and the duration of the control, which are output by the set information processing module 12f.

Using, as input data, the duration of the control of each target space that is output by the set information processing module 12f, the operation condition determination module 12c determines a set value for ending the control for each target space after the elapse of the duration of the control of the target space. The operation condition determination module 12c stores the determined set value in the storage device 11 as the air-conditioning-unit operation state data 11d. The air-conditioning-unit operation state data 11d stored in the storage device 11 by the operation condition determination module 12c is converted by the control command conversion module 12e into control command data 11e for the outdoor unit 2 and the indoor units 3, as in Embodiment 1.

The operation condition determination module 12c determines a set value for ending the control by using as input data, the control order for the target spaces which is output by the set information processing module 12f, and the space position information on each target space. The operation condition determination module 12c stores in the storage device 11, the determined set value as the air-conditioning-unit operation state data 11d. Furthermore, the operation condition determination module 12c determines whether or not a target space that has not yet been selected is present. Then, when the operation condition determination module 12c determines that a target space that has not yet been selected is present, then, for example, the set information processing module 12f determines a set value for a target space that is to be air-conditioned subsequently.

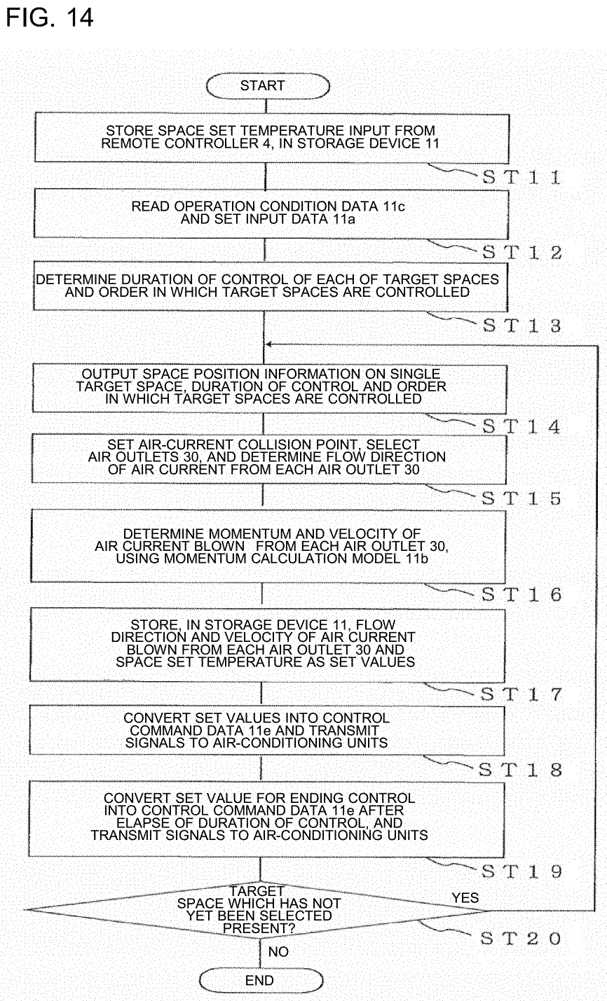

FIG. 14 is a diagram for explanation of the flow of processing by the air-conditioning control device 1 according to Embodiment 2. The processing by the air-conditioning control device 1 of Embodiment 2 performs is also performed mainly by the arithmetic device 12. The processing by the air-conditioning control device 1 will be described together with the entire flow of processing by the air-conditioning system.

In step ST11, a space set temperature for each target space that is input by an associated user 100 via the remote controller 4 therefor is transmitted to the air-conditioning control device 1 and received by the reception device 13. Then, data on the space set temperature is stored in the storage device 11 as the set input data 11a (step ST11).

In step ST12, the arithmetic device 12 reads, from the storage device 11, the operation condition data 11c, such as the control specifications of the indoor units 3, the number of the indoor units 3, and position information on the indoor units 3 and indoor shape information, and the set input data 11a including the space set temperatures (step ST12).

In step ST13, the set information processing module 12f determines the duration of the control of each of the target spaces and the control order for the target spaces (step ST13).

In step ST14, the set information processing module 12f outputs the space position information on a selected one of the target spaces to the space information processing module 12a. In addition, the set information processing module 12f outputs data on the duration of the control of the selected target space and data on the control order for the target spaces to the operation condition determination module 12c (step ST14).

In step ST15, the space information processing module 12a of the arithmetic device 12 sets an air-current collision point based on the operation condition data 11c and the set input data 11a that are obtained in step ST12. The space information processing module 12a also selects air outlets 30 of a plurality of indoor units 3 for air-conditioning the selected target space, based on the position information on the set air-current collision point. Then, the space information processing module 12a calculates, for each of the selected air outlets 30, up-down and lateral directions of air currents, relative to the air-current collision point (step ST15).

In step ST16, the momentum calculation module 12b of the arithmetic device 12 calculates the momentum of an air current blown from each selected air outlet 30, using the momentum calculation model 11b stored in the storage device 11. The momentum calculation module 12b also calculates the velocity of the air current blown from the selected air outlet 30 (step ST16).

In step ST17, the operation condition determination module 12c of the arithmetic device 12 determines as new air-conditioning set values, the flow direction of the air current from the selected air outlet 30 that is determined in step ST15, the velocity of the air current from the selected air outlet 30 that is determined in step ST16, and the space set temperature included in the set input data 11a. Then, the operation condition determination module 12c stores in the storage device 11, the determined air-conditioning set values as the air-conditioning-unit operation state data 11d (step ST17).

In step ST18, the control command conversion module 12e of the arithmetic device 12 converts the set values stored as the air-conditioning-unit operation state data 11d in the storage device 11 into the control command data 11e. The control command conversion module 12e also stores in the storage device 11, the control command data 11e obtained by the above conversion. Then, the transmission device 14 transmits signals including the control command data 11e to the outdoor unit 2 and the indoor units 3 to update the air-conditioning-unit operation state (step ST18).

In step ST19, the operation condition determination module 12c determines a set value for ending the control for the target space, after the elapse of the duration of the control that is determined in step ST13. The operation condition determination module 12c stores in the storage device 11, the determined set value as the air-conditioning-unit operation state data 11d. The air-conditioning-unit operation state data 11d stored in the storage device 11 by the operation condition determination module 12c is converted by the control command conversion module 12e into the control command data 11e for the outdoor unit 2 and the indoor units 3, as in Embodiment 1. The transmission device 14 transmits signals including the control command data 11e to an associated outdoor unit 2 and an associated indoor unit 3 and ends the control of these air-conditioning units that are air-conditioning the target space.

In step ST20, the operation condition determination module 12c determines whether or not a target space which has not yet been selected is present (step ST20). When the operation condition determination module 12c determines that a target space which has not yet been selected is present, the processing by the arithmetic device 12 returns to step ST14. Then, the set information processing module 12f performs processing related to a control of air-conditioning units for another target space (step ST14).

By contrast, when the operation condition determination module 12c determines in step ST20 that a target space which has not yet been selected is not present all the target spaces have been selected), the arithmetic device 12 of the air-conditioning control device 1 ends the processing.

As described above, in the air-conditioning control device 1 of Embodiment 2, the arithmetic device 12 further includes the set information processing module 12f, which determines the duration of the control of each target space and the control order that is an order in which the target spaces are controlled. Therefore, the air-conditioning control device 1 of Embodiment 2 can perform a control to cause the air-conditioning units to air-condition two or more target spaces one by one in a predetermined order. Thus, even when the users 100 sets different temperatures for different target spaces, the target spaces can be air-conditioned at respective desired temperatures for the users 100.

### Embodiment 3

An air-conditioning control device 1 according to Embodiment 3 will be described. It should be noted that the air-conditioning control device 1 of Embodiment 2 blows air currents to two or more target spaces one by one in a predetermined order and controls air-conditioning of each of the target spaces. By contrast. In the air-conditioning control device 1 of Embodiment 3, in spaces located just above two or more target spaces, blown air currents having different indoor-unit set temperatures are made to collide with each other and mix with each other, and mixed air obtained by this collision of the air currents is caused to reach the target spaces, thereby air-condition the target spaces at once. Also, it should be noted that in Embodiment 3, the indoor-unit set temperature of each indoor unit 3 may be different from the space set temperature.

Therefore, even when different space set temperatures are set for two or more target spaces, the air-conditioning control device 1 can cause the target spaces to be air-conditioned at the same time such that the temperatures in the target spaces reach the respective space set temperatures, while reducing as much as possible the probability with which each of the blown air currents may reach a space adjacent to an associated one of the target spaces.

The following description is made with respect to, for example, the case where the users 100b and 100c input and set different space set temperatures for different spaces at the same time, as illustrated in FIGS. 11 and 12 referred to regarding Embodiment 2, When a plurality of target spaces are air-conditioned one by one in a certain order as in Embodiment 2, it takes long time to cause the temperatures in all the target spaces to reach the respective space set temperatures, for example, in the case where the number of target spaces is very large and the difference between the temperatures of air which surrounds some users 100 and respective space set temperatures are remarkably great. Under such a condition, it may be hard to cause temperatures in target spaces in which those users 100 are present to reach desired set temperatures for the users 100.

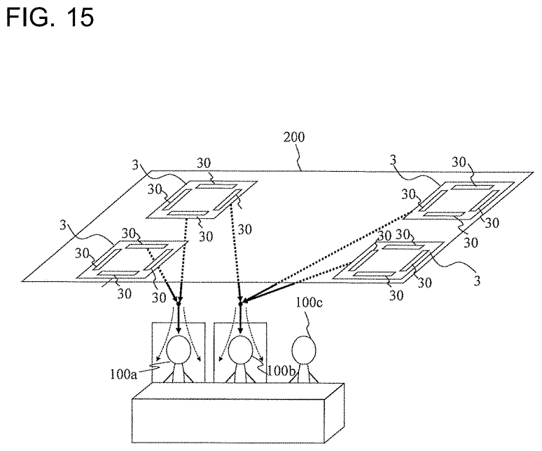

FIG. 15 is a diagram for explanation of a conceivable situation in Embodiment 3. FIG. 15 illustrates the case where the users 100a and 100b set different space set temperatures for their own positions that are respective targets, at the same time. In Embodiment 3, indoor units 3 air-condition a plurality of target spaces at the same time by supplying thereto air currents blown from a plurality of air outlets 30.

As illustrated in FIG. 15, the air-conditioning control device 1 of Embodiment 3 selects one common indoor unit 3 that blows an air current to a target space where the user 100a is present and that blows an air current to a target space where the user 100b is present. The air-conditioning control device 1 further selects indoor units 3 each of which blows an air current to an associated target space, from among indoor units 3 located around the common indoor unit 3.

Next, as an air-conditioning control of both the target space of the user 100a and the target space of the user 100b, the common indoor unit 3 and the indoor units 3 associated with the respective target spaces are caused to blow air currents having different indoor-unit set temperatures such that the blown air currents collide with each other and mix with each other at respective air-current collision points located just above the respective target spaces. At this time, the indoor-unit set temperatures of the indoor units 3 are determined such that each of the temperatures of air obtained by mixture of the blown air currents is equal to the space set temperature, which has been set by an associated one of the users 100 as the temperature of the associated target space. When the collided air flows to reach the user 100 from a position located just above the user 100, the temperature in the target space reaches the desired temperature for the user 100. In this case, air currents blown from the common indoor unit 3 have the same temperatures, since they are based on the same temperature, that is, the indoor-unit set temperature of the common indoor unit 3. The air-conditioning control device 1 then determines the indoor-unit set temperature of an indoor unit 3 associated with each of the target spaces such that when an air current blown from the indoor unit 3 collides and mixes with the blown air current from the common indoor unit 3 at the air-current collision point located just above the target space, the temperature of air obtained by the above collision and mixture reaches the space set temperature.

The space information processing module 12a, as described later, determines a target space to be required to be air-conditioned and an indoor unit or indoor units 3 for use in air-conditioning. In addition, a set temperature selection module 12h, as descried later, determines the indoor-unit set temperature of the common indoor unit 3 and the indoor-unit set temperature of each of indoor units 3 associated with the respective target spaces, using an indoor environment distribution model 11f included in the storage device 11, as described later.

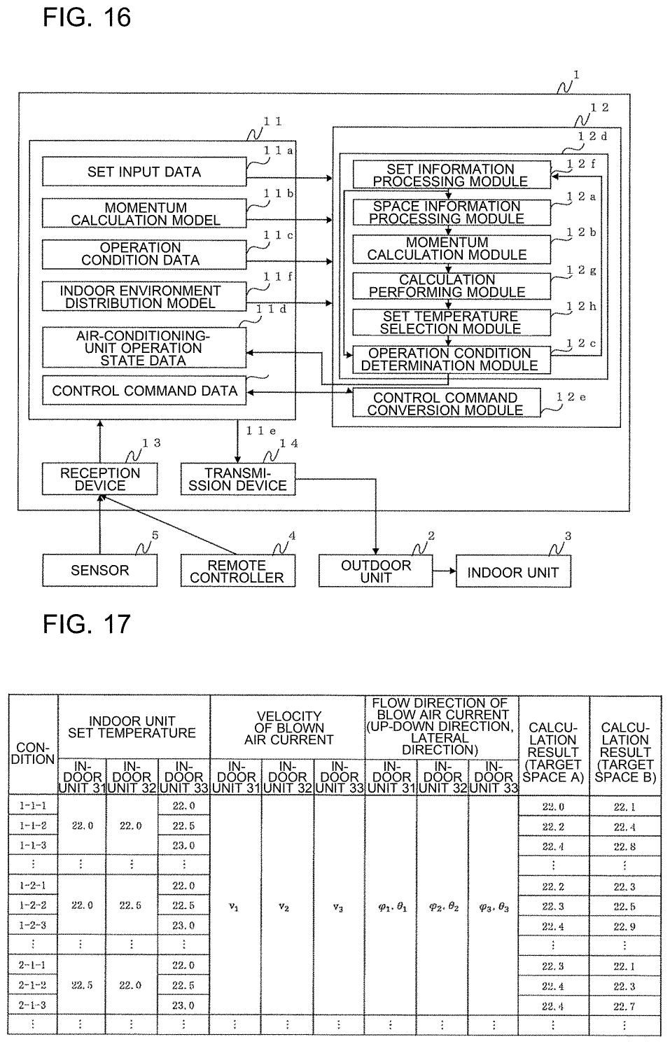

FIG. 16 illustrates a configuration example of the air-conditioning control device 1 according to Embodiment 3. In FIG. 16, components that are the same as or equivalent to those in FIGS. 5 and 13 are denoted by the same reference signs. As illustrated in FIG. 16, in the air-conditioning control device 1 of Embodiment 3, the storage device 11 further includes the indoor environment distribution model 11f. In addition, the arithmetic device 12 further includes the set temperature selection module 12h.

### <Space Information Processing Module 12a of Embodiment 3>

The space information processing module 12a of Embodiment 3 performs processing to select a plurality of target spaces to be simultaneously air-conditioned, based on the position information on the target spaces and the space set temperatures, which are set by the users 100 and included in the set input data 11a, in addition to the processing performed in Embodiments 1 and 2. The other processing by the space information processing module 12a is the same as the processing described above regarding Embodiments 1 and 2.

A method of selecting a plurality of target spaces with the space information processing module 12a is not particularly limited. As such a method, for example, the following methods are present: a method of selecting target spaces for which space set temperatures relatively close to each other are set; and a method of selecting target spaces that are located relatively close to each other.

<Indoor Environment Distribution Model 11f>

The indoor environment distribution model 11f is data obtained by modeling a relationship between environmental information on each of indoor points and information such as the flow directions and velocities of air currents blown from the indoor units 3, the space set temperatures included in the set input data 11a, data measured by the sensors 5, and the operation condition data 11c. Environments at the indoor points are temperature, radiation temperature, relative humidity, air current velocity; etc.

As a method of calculating the environments at the indoor points, there is a method in which an indoor space is divided in advance into a plurality of regions based on the shape information on the room, and the environment at each of the indoor points is obtained by analyzing a temperature and an air current velocity in an associated one of the regions, using computational fluid dynamics (CFD). Governing equations of fluid that are used in the CFD analysis can be expressed by the following equations (5) to (7), for example.

$$\begin{matrix}[ Math . 5 ] & \\ ∇ \cdot u = 0 & ( 5 )\end{matrix}$$

$$\begin{matrix}[ Math . 6 ] & \\ ρ ( \frac{\partial u}{\partial t} + u \cdot ∇ u ) = - ∇ p + ∇ \cdot ( µ ∇ u ) + ( ρ - {ρ}_{0} ) g & ( 6 )\end{matrix}$$

$$\begin{matrix}[ Math . 7 ] & \\ {C}_{p} ρ ( \frac{\partial T}{\partial t} + u \cdot ∇ T ) = ∇ \cdot ( k ∇ T ) + Q & ( 7 )\end{matrix}$$

In the equations, u is a three-dimensional velocity vector [m/s], t is a time period [s], p is a pressure [Pa], ρ is a density [kg/m³], μ is a viscosity coefficient [Pa·s], ρ₀ is a standard density [kg/m³], g is a gravitational acceleration [m/s²], Cₚ is a specific heat at constant pressure [Pa·s] or [(W·s)/(kg·degrees C.)], T is a temperature [degrees C.], k is a thermal conductivity [W/(m·degrees C.)], and Q is an internal heat generation [W/m³].

The equation (5) is a continuity equation that expresses conservation of mass for fluid. The equation (6) is an incompressible Navier-Stokes equation that expresses conservation of momentum. The equation (7) is an energy equation. A calculation performing module 12g calculates a temperature and a velocity of each of divided regions by solving the equations (5) to (7) with appropriate initial values and under boundary conditions. In this case, set values of the indoor units 3, the operation condition data 11c, the set input data 11a, and data related to measurement by the sensors 5 are used as the initial values and the boundary conditions in analysis.

<Calculation Performing Module 12g>

The calculation performing module 12g is included in the air-current passage determination module 12d. The calculation performing module 12g calculates the temperature of air obtained by collision and mixture of air currents each blown from the associated indoor unit 3 and each having the indoor-unit set temperature, for each of the target spaces, using the indoor environment distribution model 11f. In the calculation that is performed by the calculation performing module 12g, control specifications, such as the indoor-unit set temperature of each indoor unit 3 which is included in the operation condition data 11c, are used. In addition, the space set temperature included in the set input data 11a and input via the remote controller 4 by the user 100 for the target space is used. Furthermore, conditions, such as the flow directions and velocities of air currents blown from the air outlets 30, which are output by the space information processing module 12a and the momentum calculation module 12b, are used.

FIG. 17 illustrates an example of set values for air-conditioning that are used as boundary conditions in the calculation by the calculation performing module 12g according to Embodiment 3. FIG. 17 illustrates indoor-unit set temperatures and flow directions and velocities of blown air currents, which are available values for each indoor unit 3. As the flow directions and velocities of blown aft currents, values output from the space information processing module 12a and values output from the momentum calculation module 12b are used. In FIG. 17, the velocities of air currents are indicated as velocities v₁ to v₃, and the flow directions of the air currents are indicated as up-down directions ϕ₁ to ϕ₃ and lateral directions θ₁ to θ₃. By using the indoor-unit set temperature of each indoor unit 3 as a parameter, for each combination of the indoor-unit set temperatures of the indoor units 3, the temperature of air obtained by collision and mixture of blown air currents is calculated for each target space. The values indicated in the last two columns of FIG. 17 are temperatures of air in the respective target spaces that are output for each condition, FIG. 17 illustrates, as an example, calculation results for a target space A in which the user 100a is present and calculation results for a target space B in which the user 100b is present.

<Set Temperature Selection Module 12h>

The set temperature selection module 12h is included in the air-current passage determination module 12d. The set temperature selection module 12h selects a single combination of indoor-unit set temperatures of indoor units 3 to enable each of the target spaces to have a desired space set temperature, based on the results of temperature calculations for the target spaces which are performed by the calculation performing module 12g. After selecting the combination of the indoor-unit set temperatures for the indoor units 3, the set temperature selection module 12h outputs the selected indoor-unit set temperatures to the operation condition determination module 12c.

As a method of selecting indoor-unit set temperatures of indoor units 3, there is provided a method in which an indoor-unit set temperature is selected for each indoor unit 3 such that the difference between a value obtained by the temperature calculation for each target space and a space set temperature set by an associated user 100 for the target space is the smallest.

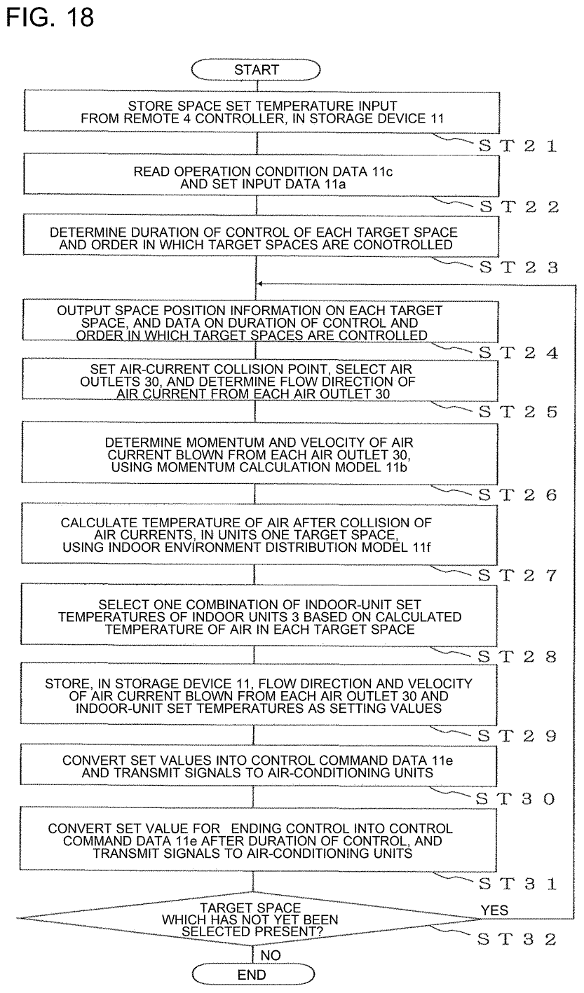

FIG. 18 is a diagram for explanation of processing by the air-conditioning control device 1 according to Embodiment 3. The processing by the air-conditioning control device 1 is performed mainly by the arithmetic device 12. The processing by the air-conditioning control device 1 will be described together with the entire flow of the processing by the air-conditioning system.

In step ST21, the space set temperature for each target space that is input by an associated user 100 via the remote controller 4 therefor is transmitted to the air-conditioning control device 1 and is received by the reception device 13. Then, the data on the space set temperature is stored in the storage device 11 as the set input data 11a (step ST21).

In step ST22, the arithmetic device 12 reads, from the storage device 11, the set input data 11a that includes the space set temperature and the operation condition data 11c, such as the control specifications, the number of the indoor units 3, and position information on the indoor units 3, and indoor shape information (step ST22).

In step ST23, the set information processing module 12f determines the duration of the control of each target space and the control order for the target spaces (step ST23).

In step ST24, the set information processing module 12f outputs the space position information on each of the target spaces to the space information processing module 12a. In addition, the set information processing module 12f outputs data on the duration of the control and the control order for the target spaces to the operation condition determination module 12c (step ST24).

In step ST25, the space information processing module 12a of the arithmetic device 12 sets an air-current collision point based on the operation condition data 11c and the set input data 11a that are obtained in step ST22. The space information processing module 12a also selects air outlets 30 of indoor units 3 for air-conditioning a selected target space, based on the position information on the set air-current collision point. Then, the space information processing module 12a calculates, for each selected air outlet 30, up-down and lateral flow directions of air currents, relative to the air-current collision point (step ST25).

In step ST26, the momentum calculation module 12b of the arithmetic device 12 calculates the moments of blown air currents blown from the selected air outlets 30, using the momentum calculation model 11b stored in the storage device 11. The momentum calculation module 12b also calculates the velocity of the air current blown from each of the selected air outlets 30 (step ST26).

In step ST27, for each of the target spaces, the calculation performing module 12g of the arithmetic device 12 calculates, using the indoor environment distribution model 11f, the temperature of air obtained by collision and mixture of the blown air currents for the target space, based on the indoor-unit set temperature available for an associated one of the indoor units 3 (step ST27).

In step ST28, the set temperature selection module 12h of the arithmetic device 12 selects, based on the temperatures of air for the target spaces that are calculated by the calculation performing module 12g, a combination of indoor-unit set temperatures of indoor units 3 to enable each of the target spaces to have an associated space set temperature (step ST28).

In step ST29, the operation condition determination module 12c of the arithmetic device 12 determines as new air-conditioning set values, the flow direction of an air current from each selected air outlet 30 that is determined by step ST25, the velocity of the air current from the selected air outlet 30 that is determined by step ST26, and the indoor-unit set temperatures. Then, the operation condition determination module 12c stores the determined air-conditioning set values in the storage device 11 as the air-conditioning-unit operation state data 11d (step ST29).

In step ST30, the control command conversion module 12e of the arithmetic device 12 converts the set values stored as the air-conditioning-unit operation state data 11d in the storage device 11 into the control command data 11e. The control command conversion module 12e also stores the control command data 11e in the storage device 11. Then, the transmission device 14 transmits signals including the control command data 11e to the outdoor unit 2 and the indoor units 3 to update the air-conditioning-unit operation state (step ST30).

In step ST31, the operation condition determination module 12c determines a set value for ending the control of the target space, after the elapse of the duration of the control that is determined in step ST23. The operation condition determination module 12c stores in the storage device 11, the determined set value as the air-conditioning-unit operation state data 11d. The air-conditioning-unit operation state data 11d stored in the storage device 11 by the operation condition determination module 12c is converted by the control command conversion module 12e into the control command data 11e for the outdoor unit 2 and the indoor units 3, as in Embodiment 1. The transmission device 14 transmits signals including the control command data 11e to the associated outdoor unit 2 and associated indoor units 3, and ends the control of these air-conditioning units that are air-conditioning the target space (step ST31).

In step ST32, the operation condition determination module 12c determines whether or not a target space which has not been selected is present (step ST32). When the operation condition determination module 12c determines that a target space which has not yet been selected is present, the processing by the arithmetic device 12 returns to step ST24. Then, the set information processing module 12f performs processing related to the control of air-conditioning units for another target space (step ST24).

By contrast, when the operation condition determination module 12c determines in step ST32 that a target space which has not yet been selected is not present (all the target spaces have been selected), the arithmetic device 12 of the air-conditioning control device 1 ends the processing.

As described above, in the air-conditioning control device 1 of Embodiment 3, the storage device 11 further includes the indoor environment distribution model 11f. In addition, the arithmetic device 12 further includes the calculation performing module 12g and the set temperature selection module 12h. Therefore, in the air-conditioning control device 1 of Embodiment 3, for each of two or more target spaces, a plurality of indoor units 3 are caused to blow air currents having different temperatures such that the blown air currents collide and mix with each other in a space located just above the target space, and air having an associated space set temperature is supplied to the target space. As a result, the above two or more target spaces are air-conditioned simultaneously. Therefore, even when a plurality of users 100 set different temperatures for respective target spaces, the air-conditioning control device 1 can cause the target spaces to be simultaneously air-conditioned at respective desired temperatures for the users 100.

### REFERENCE SIGNS LIST

1: air-conditioning control device, 2: outdoor unit, 3, 31, 32, 33, 34: indoor unit, 4, 4a to 4x: remote controller, 5, 5a, 5b: sensor, 6: control network, 11: storage device, 11a: set input data, 11b: momentum calculation model, 11c: operation condition data, 11d: air-conditioning-unit operation state data, 11e: control command data, 11f: indoor environment distribution model, 12: arithmetic device, 12a: space information processing module, 12b: momentum calculation module, 12c: operation condition determination module, 12d: air-current passage determination module, 12e: control command conversion module, 12f: set information processing module, 12g: calculation performing module, 12h: set temperature selection module, 13: reception device, 14: transmission device, 30, 30-1, 30-2, 30-3, 30i, 31a, 31b, 31c, 31d, 32a, 32b, 32c, 32d, 33a, 33b, 33c, 33d, 34a, 34b, 34c, 34d: air outlet, 100, 100a to 100x: user, 200: ceiling surface

1. An air-conditioning control device configured to control air-conditioning units that are an outdoor unit and a plurality of indoor units each having an air outlet, the air-conditioning control device comprising:
a memory to store set input data that includes a space set temperature set for a target space to be air-conditioned and space position information on the target space; and
processing circuitry configured to perform a control of the indoor units based on the set input data, such that air currents blown from the air outlets of the indoor units are caused to collide with each other in a space located just above the target space and air obtained by collision of the air currents and having the space set temperature is caused to reach the target space,
wherein the memory stores, as data, a momentum calculation model and an indoor environment distribution model, the momentum calculation model being obtained by modeling the set input data, flow directions of the air currents blown from the air outlets, and a calculation formula using a physical quantity related to each of the blown air currents as a parameter, the indoor environment distribution model being obtained by modeling a relationship between set values of the flow direction and velocity of the air current blown from each of the air outlets, the space set temperatures included in the set input data, and environmental information on each of points in a room having the plurality of target spaces,
wherein the processing circuitry includes air-current passage determination circuitry and control command conversion circuitry, the air-current passage determination circuitry being configured to determine which of the air outlets are to be used as air outlets from which the air currents are to be brown, based on the momentum calculation model, determine an operation state of each of those of the indoor units that have the determined air outlets and an operation state of the outdoor unit which supplies heat to the indoor units, and output operation state data, the control command conversion circuitry being configured to convert the operation state data output by the air-current passage determination circuitry into control command data including commands to be given to the air-conditioning units,
wherein the air-current passage determination circuitry includes
a space information processing circuitry configured to determine flow directions of the air currents blown from the air outlets of the plurality of indoor units, based on the set input data and the operation condition data including air-outlet position information on the air outlets of the plurality of indoor units,
a calculation performing circuitry configured to perform a calculation related to the environment information on the point, using the indoor environment distribution model,
a set temperature selection circuitry configured to select indoor-unit set temperatures of the plurality of indoor units, based on a result of the calculation by the calculation performing circuitry, and
an operation condition determination circuitry configured to determine, as operation condition data for the air-conditioning units, the flow directions and the velocities of the air currents flown from the air outlets and the indoor-unit set temperatures selected by the set temperature selection circuitry, and
wherein the set temperature selection circuitry is configured to perform processing to select the indoor-unit set temperatures to enable the plurality of target spaces to have the space set temperatures.

2.-3. (canceled)

4. The air-conditioning control device of claim 1, wherein the space information processing circuitry is configured to perform processing to determine flow directions of the air currents blown from the air outlets, based on an air-current collision point that is set in the space located just above the target space.

5. The air-conditioning control device of claim 1, wherein the air-current passage determination circuitry includes a momentum calculation circuitry configured to perform, using the momentum calculation model, processing to calculate a physical quantity of each of the air currents, which are blown from the air outlets such that the blown air currents reach the target space from a position just above the target space, and to determine a velocity of each of the blown air currents.

6. The air-conditioning control device of claim 5, wherein the momentum calculation circuitry is configured to perform processing to calculate as the physical quantity, a momentum of the air current blown from each of the air outlets.

7. The air-conditioning control device of claim 1, wherein the air-current passage determination circuitry includes an operation condition determination circuitry configured to determine, as operation condition data on the air-conditioning units, the flow directions and velocities of the air currents blown from the air outlets and the space set temperature included in the set input data.

8. The air-conditioning control device of claim 5, wherein the air-current passage determination circuitry includes an operation condition determination circuitry configured to determine, as operation condition data on the air-conditioning units, the flow directions and the velocities of the air currents flown from the air outlets and the space set temperature included in the set input data, the flow directions of the air currents being determined by the space information processing circuitry, the velocities of the air currents being calculated by the momentum calculation circuitry.

9. The air-conditioning control device of claim 1, wherein the arithmetic device includes a set information processing circuitry configured to determine, using the set input data, a control procedure related to air-conditioning for a plurality of target spaces including the target space.

10. The air-conditioning control device of claim 9, wherein the set information processing circuitry is configured to determine, as the control procedure, a duration of air-conditioning for each of the target spaces and an order in which the target spaces are to be air-conditioned.

11. The air-conditioning control device of claim 9, wherein ones of the air-conditioning units that are related to a selected one of the target spaces that is required to be air-conditioned are controlled based on the control procedure determined by the set information processing circuitry.

12. (canceled)

13. The air-conditioning control device of claim 1, wherein the calculation performing circuitry is configured to perform processing to calculate the temperatures of the blow air currents for the plurality of target spaces.

14. (canceled)
